(19) United States
(12) Patent Application Publication
(10) Pub. No.: US 2005/0144758 A1
(43) Pub. Date: Jul. 7, 2005

(54) Hinge for cabinets with a body closable by a door leaf with an unobstructed width narrowed on the door leaf side by at least one frame strip protruding from a body wall

(75) Inventors: Markus Herper, Muhltal (DE); Stephen Gallasch, Erbach (DE); Gabriele Schneider, Furth/Lorzenbach (DE)

Correspondence Address: NORRIS, MCLAUGHLIN & MARCUS, P.A., 875 THIRD AVE, 18TH FLOOR, NEW YORK, NY, 10022, US

(73) Assignee: MEPLA-Werke Lautenschlaeger GmbH & Co. KG, Reinheim (DE)

(21) Appl. No.: 10/835,022

(22) Filed: Apr. 28, 2004

(30) Foreign Application Priority Data
Apr. 30, 2003 (DE) 203 06 716

(51) Int. Cl. E05F 1/08

(52) U.S. Cl. 16/277

(57) ABSTRACT

Hinge (10) for pivotally attaching a door leaf (12) on the body of cabinets, whereby the unobstructed width of the open front side that can be closed by the door leaf is narrowed by at least one inwardly facing frame strip (16). The mounting plate (28) of the hinge can be pre-mounted on the inwardly facing frame strip (16), wherein the mounting plate has an attachment flange that can be screwed onto the free front face (26) of the inwardly facing frame. The attachment flange extends beyond the inside of the frame into the interior of the cabinet body. The free surface of the mounting plate facing away from the frame includes an elongated strip-like projection, on which the body stop element of the hinge (10), which is formed as an elongated support arm (24) extending over the strip-like projection, can be adjustably attached.

The invention relates to a hinge for pivotally coupling a door leaf to cabinet bodies, wherein the unobstructed width of the open front side that can be closed by the door leaf is narrowed by protruding frame strips. The mounting plate that adjustably supports the body mounting part of the hinge is pre-mounted on the frame strips and includes a mounting flange that can be screwed onto the free front side of the inwardly projecting frame. The mounting flange extends beyond the inside of the frame into the interior of the body and has on its free surface that faces away from the frame an elongated strip-like projection. The body mounting part of the hinge that is formed as an elongated support arm extending over the strip-like projection can be adjustably attached on the projection.

Cabinets with a body that has an open front side that can be closed by a door leaf and is narrowed by a frame protruding from the body walls are frequently used in Anglo-Saxon countries, for example for kitchen cabinets. The door leaves of these cabinets rest in their closed position on the outside of the frame and are pivotally attached to a vertical frame strip of the frame with special hinges referred to as “face-frame-hinges,” because these hinges cannot be attached to the inside of the vertical sidewall of the cabinet body—as with conventional frame-less cabinets. Accordingly, the body-side attachment of these hinges must be adapted to the attachment options available on the frame. In addition to hinges with specifically adapted body mounting elements, solutions have been developed (U.S. Pat. No. 4,207,652; U.S. Pat. No. 4,312,089) wherein only the mounting plates are adapted to the specific application, and the same hinges that are also used for frame-less cabinets can be mounted on the mounting plates without any modifications. The door leaves can be positioned with an adjustable height and position relative to the cabinet body by providing attachment on the special mounting plates openings in the form of slots extending in the vertical direction in the region that contacts the front edge of the respective frame strip of the body frame. The threads of fastening screws can be screwed into the frame strip through the slots. However, it soon became clear that this form of attachment has certain disadvantages, for example when frequent moves require a frequent release and retightening of the fastening screws, or when the material of the frame strip shrinks—e.g., because it dries out. The secure seat of the fastening screws can then become loose and the mounting plates can move in response to the weight of the door leaf over a distance defined by the length of the slots. In other words, the door leaves can move lower relative to the cabinet body with respect to their original correct vertical position. As a result of the required realignment, whereby the fastening screws are first loosened and then retightened after the door leaf has been raised to the correct nominal vertical position, the threads formed in the frame by the threaded screw shanks can wear out. When multiple readjustments and reattachments of the mounting plate are required, it may become impossible to tighten the fastening screws with the required tightening force, and the fastening screws can even be stripped.

It is therefore an object of the invention to provide a hinge for attaching door leaves to the aforedescribed cabinets with an inwardly projecting frame, which allows adjustment of the height of the door leaves without loosening the fastening screws for the mounting plate of the hinges.

Based on a hinge of the aforedescribed, the object is solved by the invention in that the elongated strip-like protruding projection is arranged on the top side of the attachment flange of the mounting plate and that the bottom side of the projection facing the frame is connected to a support plate by through-openings disposed in the attachment flange, with flat guide shoulders protruding from the support plate transversely to the longitudinal extent of the projection, wherein the guide shoulders engage with flat sections of a recess disposed in the bottom side of the mounting plate facing the frame, wherein the flat sections fittingly surround the guide shoulders and are longer in the longitudinal direction than the guide shoulders, and that an adjusting device is provided, which is accessible from the outside of the mounting plate that faces away from the frame and engages, on one hand, with the support plate and, on the other hand, with the mounting plate that extends over the support plate, for moving the support plate relative to the mounting plate and fixing the support plate relative to the mounting plate in a selected displacement position. The attachment of the mounting plate on the frame strip does no longer have to be loosened and—after adjustment—retightened for changing the height of the door leaves; instead, only the projection that supports the support arm of the hinge in a conventional manner is configured for adjustment relative to the mounting plate itself.

Advantageously, the mounting flange of the mounting plate includes in the region that is located in the predetermined mounting position on the front side of the frame strip at least two bores that are spaced apart in the longitudinal direction of the front side, for receiving fastening screws that can be screwed into the frame strip. These bores therefore need no longer be formed as slots, because the height can be adjusted without loosening and moving the actual mounting plate itself.

Advantageously, the fastening screws are held in the bores of the mounting flange of the mounting plate in a pre-mounting position.

In an advantageous embodiment, the unobstructed inside diameter of the bores in the mounting flange of the mounting plate is slightly smaller than the outside diameter of the fastening screw measured across the thread turns of the shank, and the shank of the respective fastening screw has an outside diameter in the region directly adjacent to the screw head that is at most equal to the unobstructed inside diameter of the corresponding bore in the mounting flange.

The fastening screw is hence pre-mounted in the mounting plate by screwing the free tip of the shaft into the corresponding bore disposed in the mounting flange of the mounting plate, whereby the crests of the threads easily penetrate the wall of the bores and thereby hold the fastening screws in the mounting position.

In an advantageous embodiment of the invention, the adjusting device for changing the height position includes an essentially cylindrical adjusting body with a smaller length, which is supported on the top side of one of the guide shoulders of the support plate that faces away from the frame strip, for rotation about an axis that is parallel to and has an eccentric offset with respect to the longitudinal cylinder axis. The cylindrical adjusting body engages with a slot-like through opening disposed in the mounting flange of the mounting plate and having a width that corresponds to the diameter of the cylindrical adjusting body. Means for applying an adjusting tool—e.g., a screwdriver slot, a Philips head slot and the like—are provided in the free outer front face of the adjusting body.

In another advantageous embodiment of the invention, connecting means are provided on the front end of the elongated projection located outside the body as well as on the front end of the hinge support arm, whereby the connecting means can be hinged so as to enable a pivoting motion of the rear end of the support arm across the rear end of the elongated projection. A swivel bolt that includes a handle projecting from the support arm is supported on the rear end of the support arm for rotation about an axis extending transversely to the support arm. The swivel bolt can be brought into locking engagement with the elongated projection in the predetermined mounting position of the support arm on the elongated projection.

In yet another advantageous embodiment, the region of the projection that protrudes from the mounting plate has two parallel lateral boundary walls that are open on the top side, wherein in the predetermined mounting position of the hinge the boundary walls protrude between the sidewalls of the support arm and have in their rearward end region locking projections with locking faces formed thereon. In the predetermined mounting position, the swivel bolt includes locking engagement faces that engage behind the locking faces of the projection, and the swivel bolt is springily pretensioned in the engagement position between the locking faces of the elongated projection and the locking engagement faces.

An embodiment of the invention will be described hereinafter in more detail with reference to the drawings, in which:

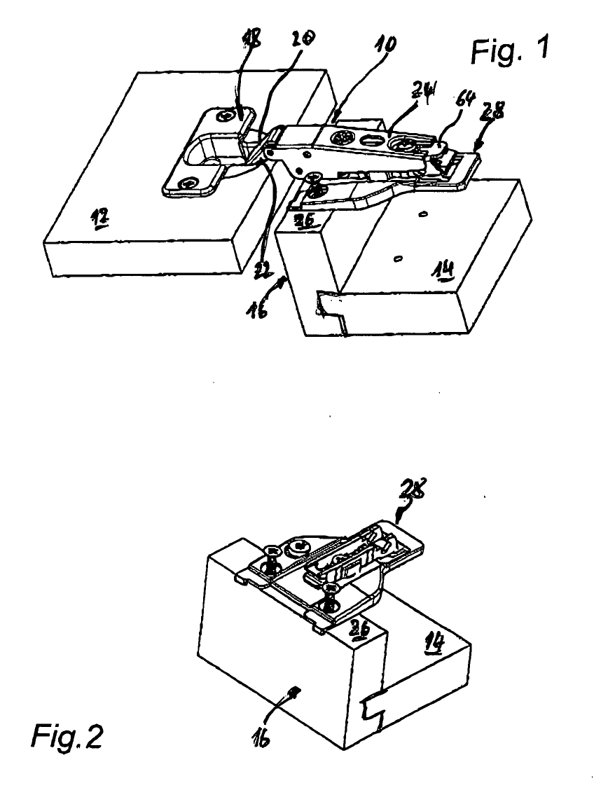

FIG. 1 shows an isometric view of a hinge according to the invention, with a support wall mounting element embodied as the support arm and adjustably supported on a mounting plate secured to a front face of a frame strip protruding from a body wall;

FIG. 2 shows at an oblique angle from above an isometric view of the mounting plate that holds the hinge of the invention on the body in the mounting position on the front side of the frame strip;

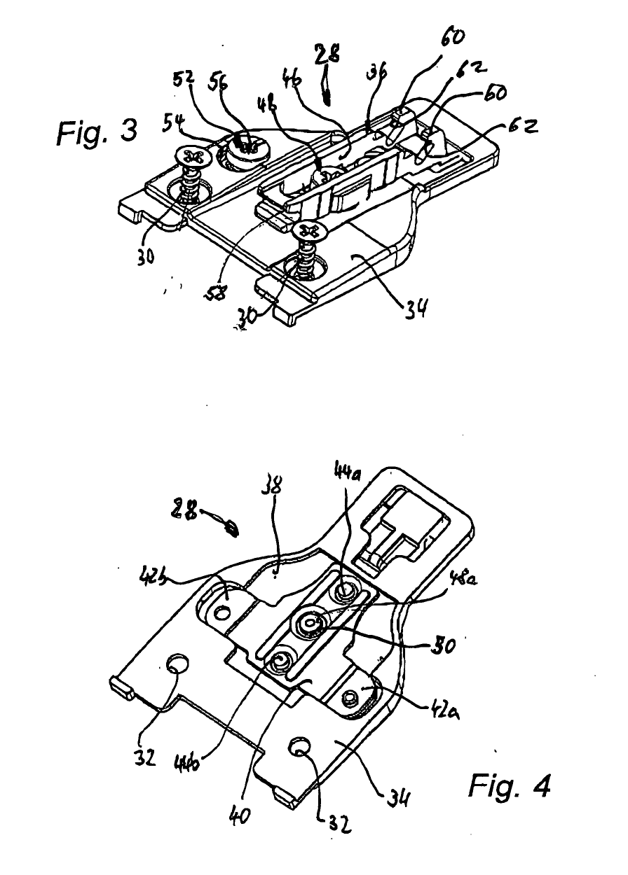

FIG. 3 shows a separate enlarged view of the mounting plate depicted in FIG. 2; and

FIG. 4 shows an isometric view of the bottom side of the mounting plate depicted in FIG. 3.

FIG. 1 shows, as indicated by reference numeral 10, an embodiment of a hinge according to the invention, designed for pivotal attachment of the door leaf 12 to a cabinet body; the open front of the cabinet body is narrowed by a frame strip 16 that protrudes inwardly from a sidewall 14 of the body. The hinge 10, which is illustrated as a conventional four-joint hinge, includes a door leaf mounting element formed as a hinge cup 18 that can be attached in a recess disposed on the inside of the door leaf. The door leaf mounting element is coupled to the front end of the body mounting element, which is oriented away from the cabinet interior, by way of two hinge arms 20, 22 which form an articulated mechanism, with the body stop element being formed as an elongated hinge arm 24. As shown in FIG. 2, the hinge arm 24 has a cross-section shaped as an inverted U and is adjustably secured on a mounting plate 28 that is screwed onto the free front side 26 of the frame strip 16.

In this particular embodiment, the support wall mounting element, i.e., the hinge arm 24 visible in FIG. 1, can be latched to and released from the mounting plate 28 by a covered intermediate plate provided in the interior of the hinge arm 24; the intermediate plate is therefore obscured in the drawing. The hinge arm can be adjusted in the horizontal direction towards and away from the cabinet interior, as well in the horizontal direction perpendicular thereto, wherein, for example, the clearance between the inside of the closed door leaf and the front face of the cabinet body, on one hand, and the rest on or overlap dimensions of the closed door leaf on the front side of the body, on the other hand, can be adjusted by a conventional mechanism (e.g. EP 1 066 440 B1) arranged between the hinge arm 24 and the intermediate plate. This aspect will therefore not be described in detail.

Another embodiment for adjusting the height of the door leaf relative to the cabinet body, which is typically realized with conventional mounting plates by forming the openings for the screw shanks of the fastening screws as slots extending in the desired height adjustment direction, could also be implemented with the present attachment of the mounting plate on the front side 26 of the frame strip 16, but may be somewhat problematic, because the surfaces available for a force-transmitting press fit of the mounting plate 28 on the front side 26 are relatively small, and the attachment can become loose due to shrinkage of the material used for the frame strips—for example, because the frame strips dry out—or due to damage to the threads formed by the fastening screws in the frame strip after multiple height adjustments of the hinges. All these effects can impair engagement of the thread of the fastening screws in the frame strip and may even tear the fastening screws from the fastening bore. In the hinge according to the invention, the mechanism for adjusting the height of the hinge is still incorporated in the design of the mounting plate 28; however, the mounting plate is attached on the front side 26 of the frame strips by fastening screws 30, which extends through matching fastening bores 32, and which therefore do not permit movement of the mounting plate 28 after the initial installation of the mounting plate 28.

As seen in FIG. 3 and 4, which separately show the mounting plate 28, the front region of the mounting plate that is to be fastened on the front side 26 of the frame strip includes a wider attachment flange 34 which has a decreasing width in the end region that projects into the interior of the cabinet body. A separately fabricated elongated strip-like projection 36 is arranged approximately in the center of the attachment flange. The support arm 24 of the hinge 10 can latch on the projection 36 through the aforementioned intermediate plate in a manner known in the art. The projection 36 is connected with a support plate 40 that is held for transverse movement in a shallow recess 38 disposed in the bottom side of the attachment flange 34. Flat guide projections 42a, 42b protrude from opposing sides of the support plate and engage with corresponding complementary sections 38a, 78b of the recess 38 to secure the support plate 40 against rotation in the recess. The strip-like projection 36 can be connected to the support plate 40, for example, with screws and/or rivets.

FIG. 4 shows the riveted ends 44a, 44b of the shanks of two connecting rivets, with the rivet heads resting on the bottom of a longitudinal recess 46 of the strip-like projection 36 that is open towards the top. The rivet shanks (not shown) extend through slots in the attachment flange 34 that are covered by the support plate 40 and are therefore obscured in the drawing. In addition, a cylindrical adjusting element 48 is provided midway between the connecting rivets, as shown in FIG. 3. The shank 48a protruding eccentrically from the bottom side of the cylindrical adjusting element 48 is rotatably supported in a bore in the support plate 40. The cylindrical peripheral surface of the cylindrical adjusting element 48 in turn rests on the opposing longitudinal edges of a slot (not shown) located in the bottom face of the projection 36 and oriented perpendicular to the strip-like projection 36. The strip-like projection 36—and therefore also the hinge arm of a hinge supported on the projection 36—can be adjusted on the mounting flange in the longitudinal direction by rotating the cylindrical adjusting element 48 with a Philips screwdriver inserted in the Philips screw slots provided in the upper end face visible in FIG. 3.

For continuous fine adjustment of the strip-like projection 36 on the mounting flange 34 of the mounting plate 28, an adjusting device in the form of an additional, essentially cylindrical adjusting element 52 is provided which is supported on the top side of the lower guide projection 42a (as illustrated in FIG. 4) for rotation about an axis that is parallel and eccentric to the longitudinal cylinder axis. The cylindrical adjusting element 52 is fittingly received in a slot-like through opening 54 that extends parallel to the strip-like projection 36, and has on its fee upper end face a Philips head slot 56 adapted for engagement with a Philips head screwdriver. To adjust the height of the elongated projection, the locking screw 48 is loosened with a Philips head screwdriver and the cylindrical adjusting device is rotated, thereby changing the height of the support plate 40 relative to the attachment flange 34 due to the eccentric support of the adjusting element 52, which in turn also changes the height of the strip-like projection 36 in the height direction. After the height is adjusted, the locking screw 48 is again tightened to fix the adjusted height position.

As already mentioned, the mounting plate 28 is secured on the front face 26 of the fame strip 16 with the fastening screws 30, which are screwed into the frame strip 16 in the determined mounting position after the mounting plate 28 is placed on the front face 26. Advantageously, the fastening screws 30 are pre-mounted in corresponding fastening bores 32 of the attachment flange 34 of the mounting plate 28 in the position depicted in FIGS. 2 and 3, for example by making the diameter of the fastening screws 30, as measured across the outer thread turns, slightly larger than the unobstructed diameter of the fastening bores 32. The screws 30 can then be inserted into the fastening bore 32 and rotated by one or more turns in the insertion direction. The thread turns then cut a shallow counter thread in the walls of the bores 32, thus holding the fastening screws 30 in the pre-mounting position. In the rear region directly adjacent to the screw heads, the screw shank can have a slightly smaller diameter than the diameter of the bores 32—for example by grinding the thread down—, so that the thread can always be screwed in until the screw head is secured tightly on the top side of the attachment flange.

The front end of the elongated projection 36, which in the predetermined mounting position is covered by the support arm 12 of the hinge 10, has a transverse recess 58. A transversely oriented pin provided in the support arm or a hook-like projection of the intermediate plate can be hinged in the transverse recess 58. Locking projections 60 with locking faces 62 are formed in the raised walls that the laterally bound the longitudinal recess 46 on the rear end of the strip-like projection 36. The locking faces 62 can then be brought into engagement with locking engagement faces of a pivoting bar that can rotate about a transverse axis and is pretensioned by springs disposed on the rear and of the intermediate plate. FIG. 1 shows only the extension 64 of the pivoting bar which projects from the hinge arm 24 to the rear and serves as a release handle.

1. Hinge (10) for pivotally coupling a door leaf (12) on cabinet bodies, wherein the unobstructed width of the open front side that can be closed by the door leaf (12) is narrowed by protruding frame strips (16), on which frame strips (16) the mounting plate (28) that adjustably supports the body mounting part of the hinge is pre-mounted, the mounting plate (28) comprising a mounting flange (34) that can be screwed onto the free front side (26) of the inwardly projecting frame, the mounting flange (34) extending beyond the inside of the frame into the interior of the body and having on its free surface that faces away from the frame an elongated strip-like projection (36), on which projection (36) the body mounting part of the hinge that is formed as an elongated support arm (24) extending over the strip-like projection (36) can be adjustably attached, characterized in
that the elongated strip-like protruding projection (36) is arranged on the top side of the attachment flange (34) of the mounting plate (28) and that the bottom side of the projection (36) facing the frame is connected to a support plate (40) by through-openings disposed in the attachment flange, with flat guide shoulders (42a; 42b) protruding from the support plate (40) transversely to the longitudinal extent of the projection (36), wherein the guide shoulders (42a; 42b) engage with flat sections (38a; 38b) of a recess (38) disposed in the bottom side of the mounting plate (28) facing the frame, wherein the flat sections (38a; 38b) fittingly surround the guide shoulders and are longer in the longitudinal direction than the guide shoulders, and
that an adjusting device is provided, which is accessible from the outside of the mounting plate (28) that faces away from the frame and engages, on one hand, with the support plate (40) and, on the other hand, with the mounting plate (28) that extends over the support plate (40), for moving the support plate (40) relative to the mounting plate (28) and fixing the support plate (40) relative to the mounting plate (28) in a selected displacement position.

2. Hinge according to claim 1, characterized in that the mounting flange (34) of the mounting plate (28) comprises in the region located in the predetermined mounting position on the front side (26) of the frame strip (16) at least two bores (32) that are spaced in the longitudinal direction of the front side, for receiving fastening screws (30) that can be screwed into the frame strip (16).

3. Hinge according to claim 2, characterized in that the fastening screws (30) are held in the bores (32) of the mounting flange (34) of the mounting plate (28) in a pre-mounting position.

4. Hinge according to claim 3, characterized in that the unobstructed inside diameter of the bores (32) in the mounting flange (34) of the mounting plate (28) is slightly smaller than the outside diameter of the fastening screw (32) measured across the thread turns of the shank, and that the shank of the respective fastening screw (30) has an outside diameter in the region directly adjacent to the screw head that is at most equal to the unobstructed inside diameter of the corresponding bore (32) in the mounting flange (34).

5. Hinge according to claim 3 or 4, characterized in that the fastening screws (30) are pre-mounted by screwing the free tip of their shaft into the corresponding bore (32) disposed in the mounting flange (34) of the mounting plate (28).

6. Hinge according to one of the claims 1 to 5, characterized in that the adjusting device comprises an essentially cylindrical adjusting body (52) with a small length, which is supported on the top side of one of the guide shoulders (42a) of the support plate (40) that faces away from the frame strip, for rotation about an axis that is parallel to and has an eccentric offset with respect to the longitudinal cylinder axis, that the cylindrical adjusting body (52) engages with a slot-like through opening (54) disposed in the mounting flange (34) of the mounting plate (28) and having a width that corresponds to the diameter of the cylindrical adjusting body (52), and that means for applying an adjusting tool are provided in the free outer front face of the adjusting body (52).

7. Hinge according to one of the claims 1 to 6, characterized in that connecting means are provided on the front end of the elongated projection (36) located outside of the body as well as on the front end of the hinge support arm (24), whereby the connecting means can be hinged so as to enable a pivoting motion of the rear end of the support arm (24) across the rear end of the elongated projection (36), and that a swivel bolt that includes a handle projecting from the support arm (24) is supported on the rear end of the support arm (24) for rotation about an axis extending transversely to the support arm (24), wherein in the predetermined mounting position of the support arm (24) on the elongated projection (36), the swivel bolt can be brought into locking engagement with the elongated projection.

8. Hinge according to claim 7, characterized in that the region of the projection (36) that protrudes from the mounting plate (28) has two parallel lateral boundary walls that are open on the top side, wherein in the predetermined mounting position of the hinge (10) the boundary walls protrude between the sidewalls of the support arm (24) and have in their rearward end region locking projections (60) with locking faces (62) formed thereon, that in the predetermined mounting position, the swivel bolt includes locking engagement faces that engage behind the locking faces (62) of the projection (36) and is springily pretensioned in the engagement position between its locking engagement faces and the locking faces (62) of the elongated projection (36).
